(19) United States
(12) Patent Application Publication
(10) Pub. No.: US 2020/0298674 A1
(43) Pub. Date: Sep. 24, 2020

(54) PRIVACY WINDOW AND DISPLAY FOR VEHICLE

(71) Applicant: Inteva Products, LLC, Troy, MI (US)

(72) Inventors: Brian H. Staser, Oxford, MI (US); Ashley Simpson, Royal Oak, MI (US); Aidano Nascimento, Oakland, MI (US)

(21) Appl. No.: 16/824,304

(22) Filed: Mar. 19, 2020

Related U.S. Application Data
(60) Provisional application No. 62/821,089, filed on Mar. 20, 2019.

(51) Int. Cl. B60J 1/00; B60J 1/20; B60R 11/02; E06B 9/24; E05F 15/00; G02F 1/1334

(52) U.S. Cl. CPC B60J 1/004; B60J 1/20; B60R 11/0229; B60R 2011/0026; E05F 15/00; G02F 1/1334; E06B 9/24

(57) ABSTRACT

A privacy window module for use in a vehicle interior, including: a window deployable between a stowed position and a deployed position, the window being movably located between a first panel and a second panel of the privacy window module; and a screen located on a first surface of the window the screen capable of presenting graphics on its surface.

### CROSS REFERENCE TO RELATED APPLICATIONS

This application claims priority to the following U.S. Provisional Patent Application, Ser. No. 62/821,089 filed on Mar. 20, 2019 the contents of which are incorporated herein by reference thereto.

### BACKGROUND

Exemplary embodiments of the present disclosure pertain to privacy windows for use in vehicles. More particularly, a privacy window that may include various features.

In some vehicles it is desirable to provide a privacy window that will insulate the rear passengers from the driver and/or the front seat. Accordingly, it is desirable to provide a privacy window that may include various features.

### BRIEF DESCRIPTION

Disclosed is a privacy window module for use in a vehicle interior, including: a window deployable between a stowed position and a deployed position, the window being movably located between a first panel and a second panel of the privacy window module; and a screen located on a first surface of the window the screen capable of presenting graphics on its surface.

In addition to one or more of the features described above, or as an alternative to any of the foregoing embodiments, the window has a polymer dispersed liquid crystal (PDLC) film applied to a second surface of the window, the first surface being opposite to the second surface.

In addition to one or more of the features described above, or as an alternative to any of the foregoing embodiments, the window transitions from opaque to translucent upon application of a current to the polymer dispersed liquid crystal (PDLC) film.

In addition to one or more of the features described above, or as an alternative to any of the foregoing embodiments, the first surface is a passenger side surface of the window and the second surface is a driver's side of the window.

In addition to one or more of the features described above, or as an alternative to any of the foregoing embodiments, the first panel is a driver's side panel and the second panel is a passenger side panel.

In addition to one or more of the features described above, or as an alternative to any of the foregoing embodiments, the driver's side panel and the passenger side panel are each configured to extend between B-pillars of a vehicle.

In addition to one or more of the features described above, or as an alternative to any of the foregoing embodiments, the screen is at least one of a video monitor or a television screen.

In addition to one or more of the features described above, or as an alternative to any of the foregoing embodiments, the privacy window module includes a regulator for moving the window between the stowed position and the deployed position, the regulator being secured to either the first panel or the second panel.

In addition to one or more of the features described above, or as an alternative to any of the foregoing embodiments, an opening is provide in the privacy window module when the window is in the stowed position.

Also disclosed is a privacy window module for use in a vehicle interior, including: a window deployable between a stowed position and a deployed position, the window being movably located between a first panel and a second panel of the privacy window module; and a screen deployable between a stowed position and a deployed position, the screen being movably located between the first panel and the second panel of the privacy window module, the screen and the window being capable of independent movement with respect to each other and the screen being capable of presenting graphics on its surface.

In addition to one or more of the features described above, or as an alternative to any of the foregoing embodiments, the window has a polymer dispersed liquid crystal (PDLC) film applied to a surface of the window.

In addition to one or more of the features described above, or as an alternative to any of the foregoing embodiments, the window transitions from opaque to translucent upon application of a current to the polymer dispersed liquid crystal (PDLC) film.

In addition to one or more of the features described above, or as an alternative to any of the foregoing embodiments, when the window is in the deployed position and the screen is in the deployed position, the screen is on a passenger side of the privacy window module and the window is on a driver's side of the privacy window module.

In addition to one or more of the features described above, or as an alternative to any of the foregoing embodiments, the first panel is a driver's side panel and the second panel is a passenger side panel.

In addition to one or more of the features described above, or as an alternative to any of the foregoing embodiments, the driver's side panel and the passenger side panel are each configured to extend between B-pillars of a vehicle.

In addition to one or more of the features described above, or as an alternative to any of the foregoing embodiments, the screen is at least one of a video monitor or a television screen.

In addition to one or more of the features described above, or as an alternative to any of the foregoing embodiments, the privacy window module includes a regulator for moving the window and the screen between the stowed position and the deployed position, the regulator being secured to either the first panel or the second panel.

In addition to one or more of the features described above, or as an alternative to any of the foregoing embodiments, the regulator is a dual system regulator comprising a first pair of cursors slidably received on a pair of guide rails and a second pair of cursors slidably received on the pair of guide rails, the pair of guide rails being configured so that the first pair of cursors and the second pair of cursors slide in different paths with respect to each other such that the window and the screen move independently with respect to each other, the first pair of cursors being are configured to be secured a portion of the window and the second pair of cursors are configured to be secured to a portion of the screen.

In addition to one or more of the features described above, or as an alternative to any of the foregoing embodiments, the first pair of cursors are driven up and down the pair of guide rails by a first cable secured to the first pair of cursors at one end and a first cable drum, the first cable drum being driven by a first motor and the second pair of cursors are driven up and down the pair of guide rails by a second cable secured to the second pair of cursors at one end and a second cable drum at the other end, the second cable drum being driven by a second motor.

Also disclosed is a method of deploying a privacy window module for use in a vehicle interior, including: deploying a window between a stowed position and a deployed position, the window being movably located between a first panel and a second panel of the privacy window module; and deploying a screen between a stowed position and a deployed position, the screen being movably located between the first panel and the second panel of the privacy window module, the screen and the window being capable of independent movement with respect to each other and the screen being capable of presenting graphics on its surface.

### BRIEF DESCRIPTION OF THE DRAWINGS

The following descriptions should not be considered limiting in any way. With reference to the accompanying drawings, like elements are numbered alike:

FIG. 1 is a perspective view of a vehicle interior with a privacy window module of the present disclosure in an open position;

FIG. 2 is a perspective view of a vehicle interior with a privacy window module of the present disclosure in a midway position between an open position and a closed position;

FIG. 3 is a perspective view of a vehicle interior with a privacy window module of the present disclosure in a closed position;

FIG. 4 is a perspective view of a vehicle interior with a privacy window module of the present disclosure in a closed position, wherein a window of the privacy window module is configured to present graphics on the window;

FIG. 5 is a perspective view of a vehicle interior with a privacy window module of the present disclosure in a closed position, wherein a window of the privacy window module has a polymer dispersed liquid crystal (PDLC) film applied to the window;

FIG. 6 is a perspective view of a vehicle interior with a privacy window module of the present disclosure in a closed position, wherein a window of the privacy window module has a polymer dispersed liquid crystal (PDLC) film applied to a driver's side of the window and a display screen is applied to the passenger side of the window;

FIG. 7 is a perspective view of a vehicle interior with a privacy window module of the present disclosure, wherein a blackout display is applied to a driver's side of the window;

FIG. 8 is a perspective view of a vehicle interior with a privacy window module of the present disclosure, wherein a blackout display is applied to a driver's side of the window and a display monitor is located on the passenger side of the window;

FIG. 9 is a perspective view of a driver's side panel of the privacy window module of the present disclosure;

FIG. 10 is a perspective view of a driver's side panel of the privacy window module of the present disclosure;

FIG. 11 is an exploded view of the privacy window module of the present disclosure;

FIG. 12 is a perspective view of a privacy window module of the present disclosure, wherein a display screen, monitor or television screen of the privacy window module is in an up or deployed position;

FIG. 13 is a perspective view of a privacy window module of the present disclosure, wherein a display screen, monitor or television screen of the privacy window module is in a down position or stowed position and the privacy glass is illustrated in an up or deployed position;

FIG. 14 is a perspective view of a privacy window module of the present disclosure, wherein a display screen, monitor or television screen of the privacy window module is in a down position or stowed position and the privacy glass is in a down or stowed position;

FIG. 15 is a perspective view of a regulator for movement of the display screen, monitor or television screen and the privacy glass of the privacy window module between a down position or stowed position and an up or deployed position;

FIG. 16 is a perspective view of a vehicle interior with a privacy window module of the present disclosure in an open or stowed position; and

FIG. 17 is a perspective view of a vehicle interior with a privacy window module of the present disclosure in a closed position or deployed position.

### DETAILED DESCRIPTION

A detailed description of one or more embodiments of the disclosed apparatus and method are presented herein by way of exemplification and not limitation with reference to the FIGS.

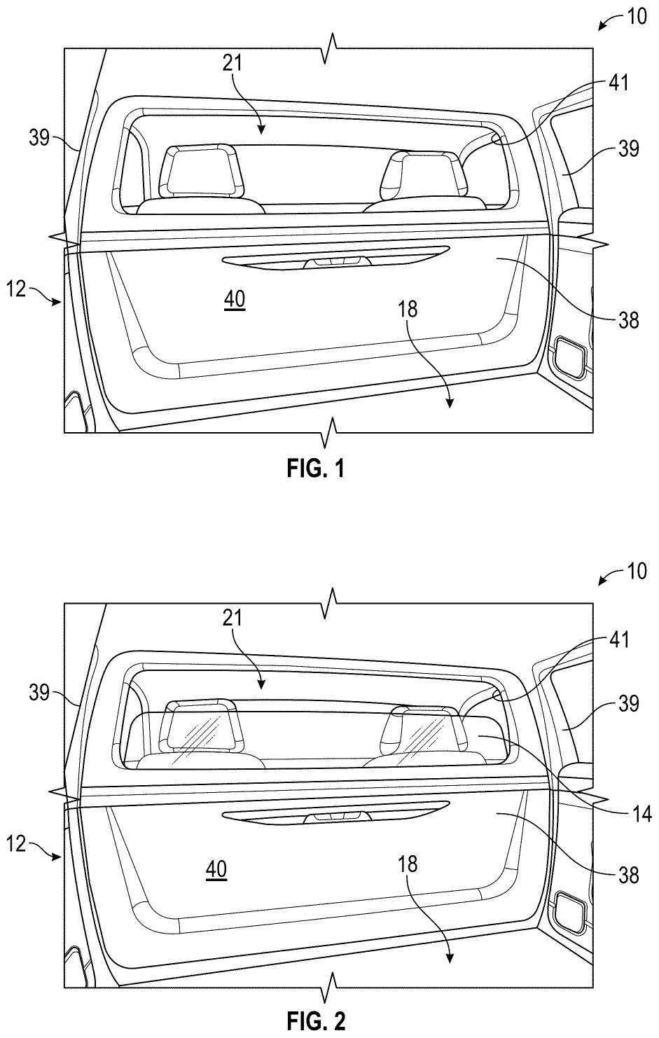

Referring now to FIG. 1, a perspective view of a vehicle interior 10 with a privacy window module 12 of the present disclosure is illustrated. In FIG. 1 the privacy window module 12 is in an open position.

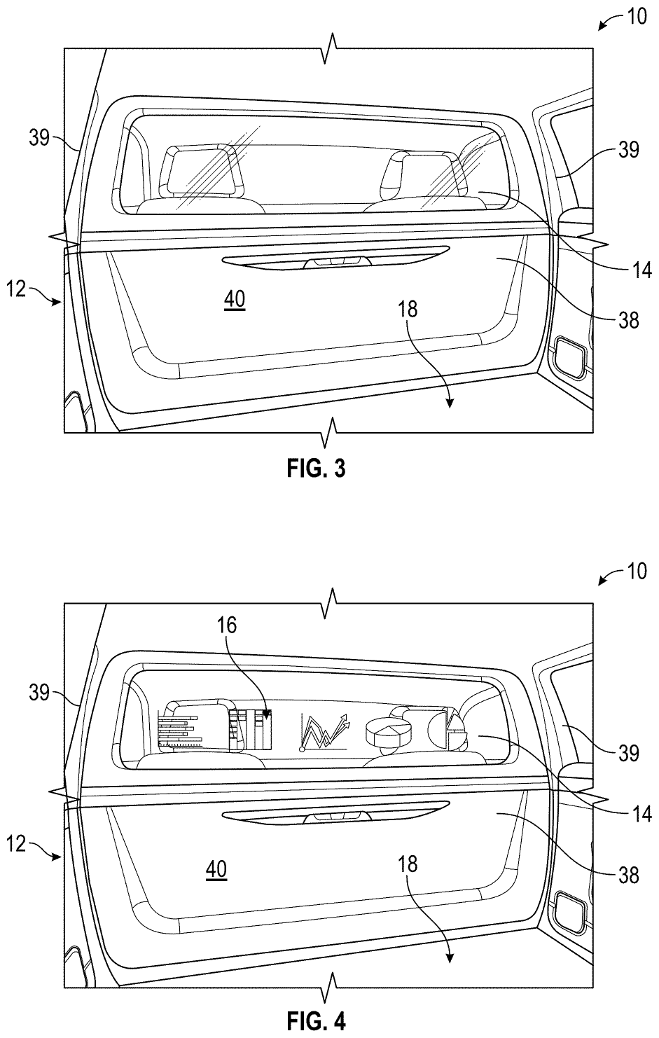

In FIG. 2, the privacy window module 12 is in a midway position between an open position and a closed position. As illustrated, a window 14 of the privacy window module 12 is illustrated in the midway position. FIG. 3 illustrates the window 14 of the privacy window module 12 in a closed position. In accordance with various embodiments of the present disclosure, the window 14 of the privacy window module 12 may be clear or opaque. In addition and as will be discussed herein, the window 14 of the privacy window module 12 may be configured to present graphics 16 on a surface of the window that faces a passenger compartment 18 of the vehicle interior 10. See at least FIG. 4. The graphics 26 may be displayed a screen, monitor or television screen or alternatively they may be projected onto the window 14.

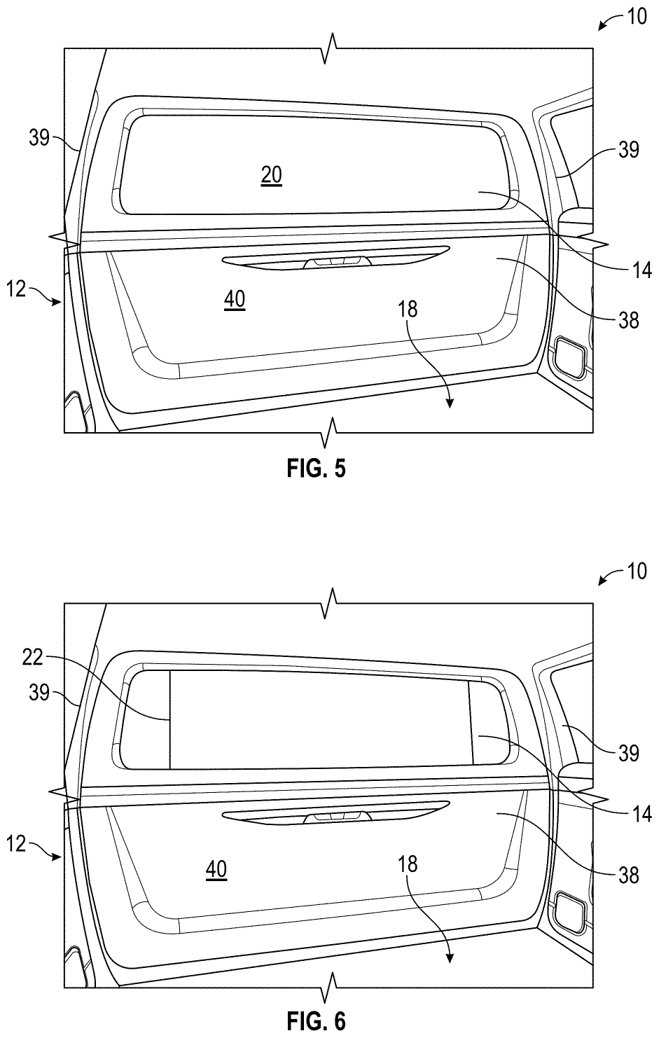

In yet another embodiment and referring now to at least FIG. 5, the window 14 of the privacy window module 12 may have a polymer dispersed liquid crystal (PDLC) film 20 applied to the window such that film 20 and/or the window 14 can transition between an opaque state or a translucent state upon application of a current to the polymer dispersed liquid crystal (PDLC) film 20.

As used herein a PDLC film 20 refers to of a polymer matrix of liquid crystals enclosed by electrically conductive Indiium Tin Oxide-coated PIET film. The PDLC film 20 may include two sheets of glass that are laminated over the PDLC film, The PDLC Film has wiring attached to a conductive copper strip located along the film's edge, wherein when the electric current is not supplied to the conductive copper strip the liquid crystal molecules are randomly oriented and will scatter incidental light, which renders the film opaque or partially translucent. When the electric current is applied, the liquid crystal molecules will line up and incidental light passes through, thus rendering the film as being clear. As such, a user may change the amount of light that will pass through the film 20. These components are assembled to form a single unit, which generically referred to as the PDLC film 20. In one embodiment, the PDLC film 20 with all of the components including the two sheets of glass may comprise window 14. As such, the window 14 can be configured to include the PDLC film 20 and/or the screen as part of a laminated glass as an interlayer. Alternatively, the PDLC film may be separately applied to window 14.

Referring now to FIG. 6, the polymer dispersed liquid crystal (PDLC) film 20 is applied to a driver's side of the window 14 that faces a driver's compartment 21 of the vehicle interior 10 and a display screen, monitor or television screen 22 of the privacy window module 12 is applied to the passenger side of the window 14. Here the display screen, monitor or television screen 22 may be a liquid crystal display capable of presenting graphics to an individual located in the passenger compartment 18 of the vehicle interior 10. Alternatively, the display screen or monitor 22 may be a touch screen. In yet another alternative, screen 22 may simply be a video monitor or be a screen capable of having an image projected thereon by for example a projector located within the passenger compartment 18.

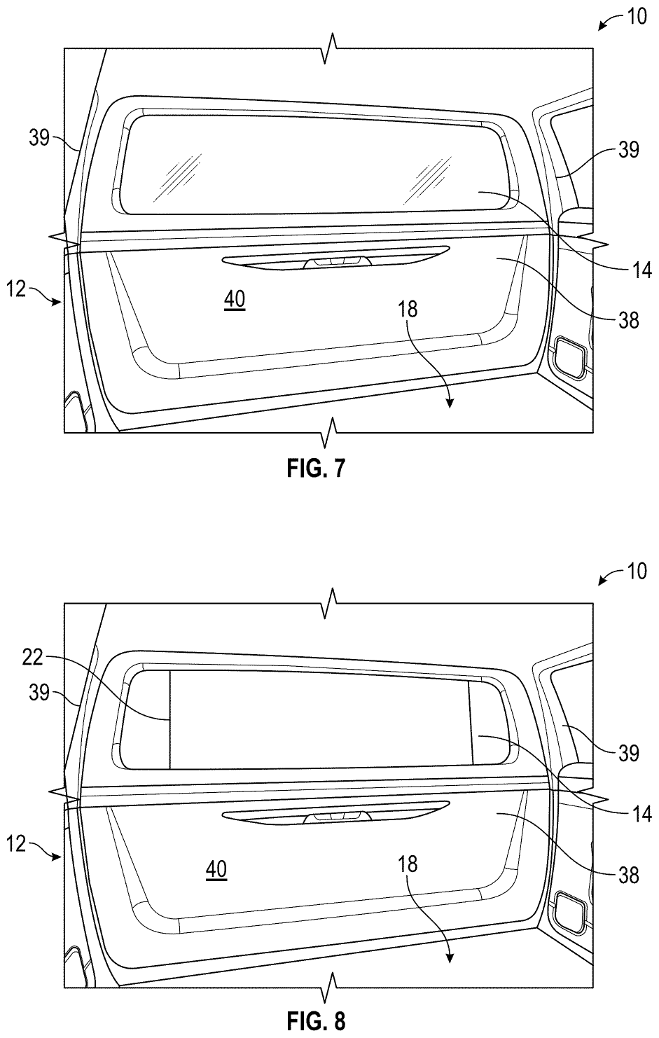

Referring now to FIG. 7, the vehicle interior 10 is illustrated with a privacy window module 12 of the present disclosure, wherein a blackout display is applied to a driver's side of the window 14. In one embodiment, the blackout display may be a PDLC film 20 as mentioned above or alternatively the driver's side of the window may by simply tinted. This blackout display will provide privacy between an individual viewing a display screen, monitor or television screen of the privacy window module 12.

Referring now to FIG. 8, the vehicle interior 10 is illustrated with a privacy window module 12 of the present disclosure, wherein a blackout display (e.g., PDLC film 20 or tinting) is applied to a driver's side of the window 14 and a display screen, monitor or television screen 22 is located on the passenger side of the window. Alternatively, the display screen, monitor or television 22 is separately deployable by the privacy window module 12.

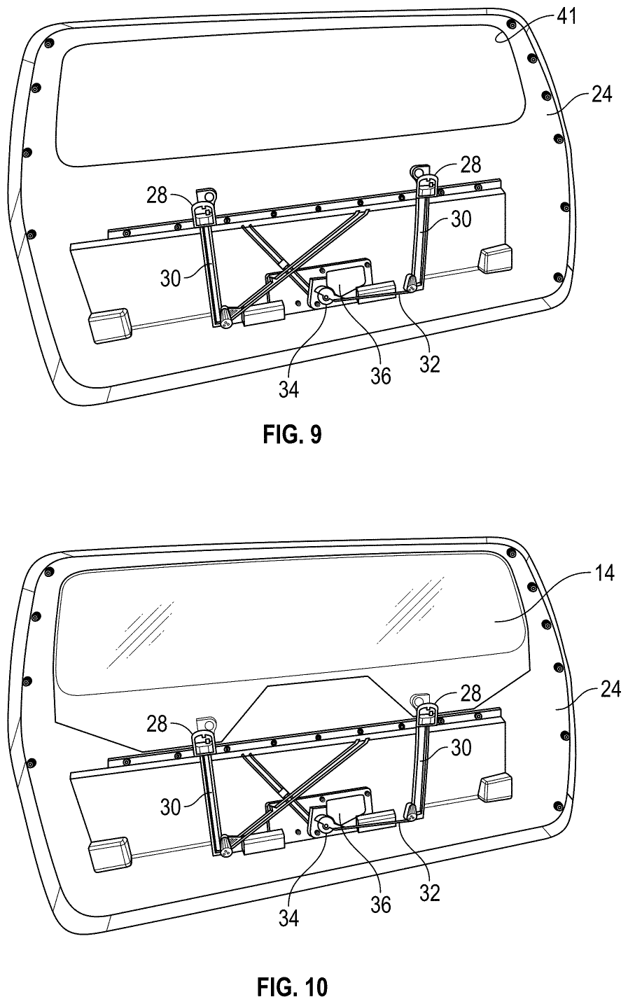

Referring now to FIG. 9, a first or a driver's side panel 24 of the privacy window module 12 of the present disclosure is illustrated. A window regulator 26 is mounted to the first or a driver's side panel 24 in order to provide for deployment of the window 14. The window regulator 26 includes cursors 28 that are slidably received on guide rails 30, which are secured to the first or the driver's side panel 24 and the cursors are driven by a cable 32 secured to the cursors 28 at one end and a cable drum 34 at the other end. The cable drum being driven by a motor 36. The cursors 28 are configured to be secured to a portion of the window 14 so that it may be deployment from a stowed position to a deployed position. Alternatively, the window regulator 26 may be secured to a second or passenger interior trim panel 38 of the privacy window module 12.

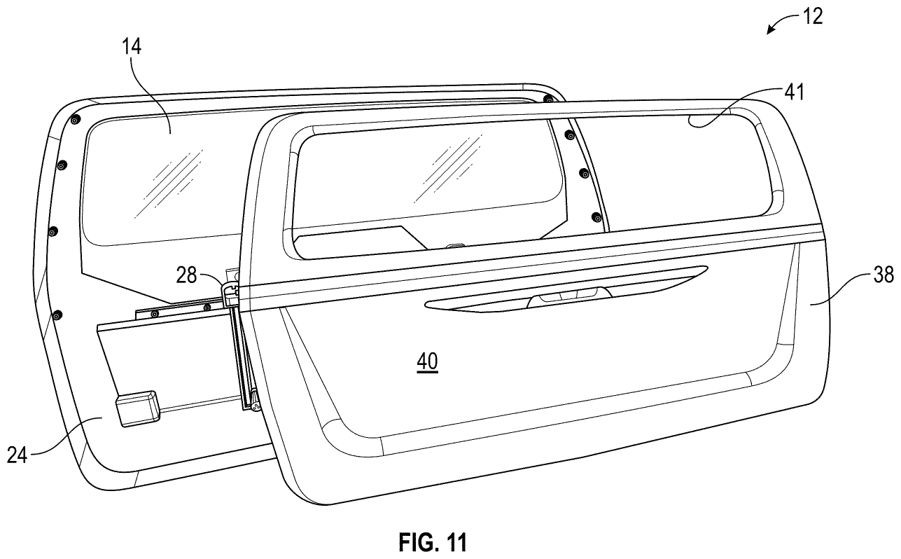

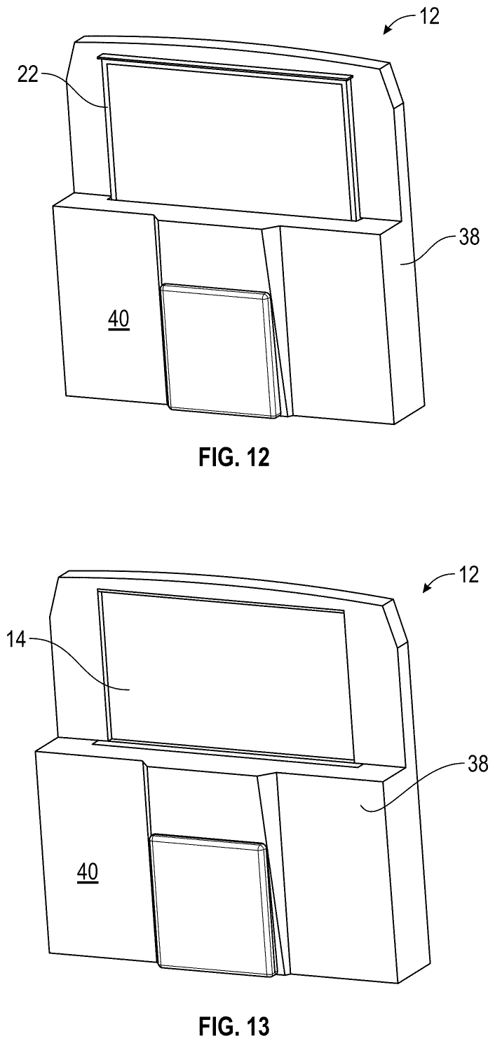

FIG. 10 illustrates the window 14 of the privacy window module 12 secured to the cursors 28 of the window regulator 26. Referring now to FIG. 11 an exploded view of the privacy window module 12 of the present disclosure is illustrated. Here, the second or passenger interior trim panel 38 of the privacy window module 12 is illustrated before it is secured to the first or the driver's side panel 24 of the privacy window module 12. An interior surface 40 of the second or passenger interior trim panel 38 may have any configuration and/or features suitable for the passenger's needs. In one embodiment, the driver's side panel 24 and/or the passenger side panel 38 are configured to extend between and/or be secured to B-pillars 39 of the vehicle frame.

Referring now to FIG. 12, an alternative configuration of a privacy window module 12 of the present disclosure is provided. Here a display screen, monitor or television screen 22 of the privacy window module 12 is in an up or deployed position.

Referring now to FIG. 13, the display screen, monitor or television screen 22 of the privacy window module 12 is in a down position or stowed position and the window or privacy glass 14 is illustrated in an up or deployed position. It being understood that when the window or privacy glass 14 is in the deployed position and the display screen, monitor or television screen 22 is in the deployed position, the display screen, monitor or television screen 22 is on a passenger side of the privacy window module 12 and the window or privacy glass 14 is on a driver's side of the privacy window module 12.

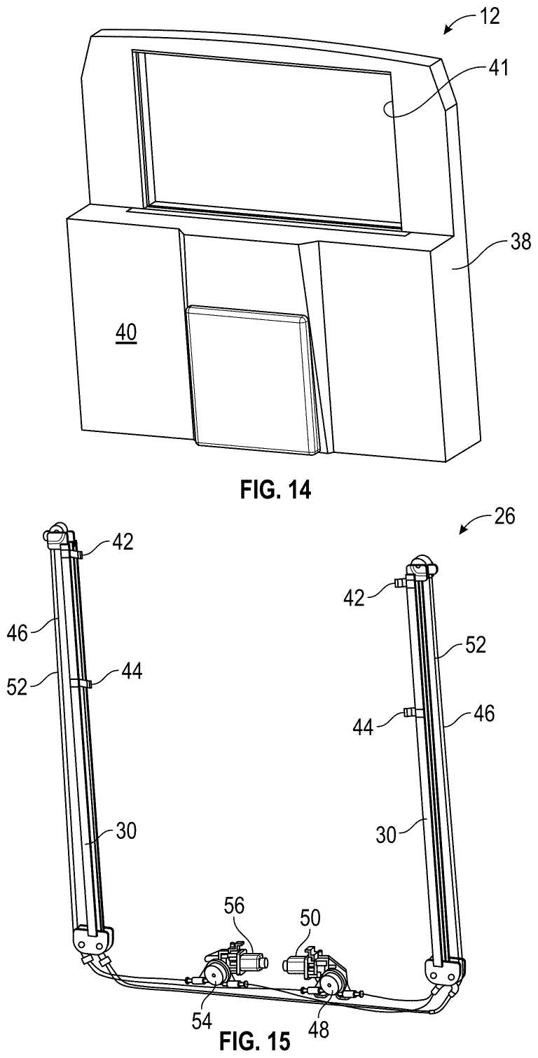

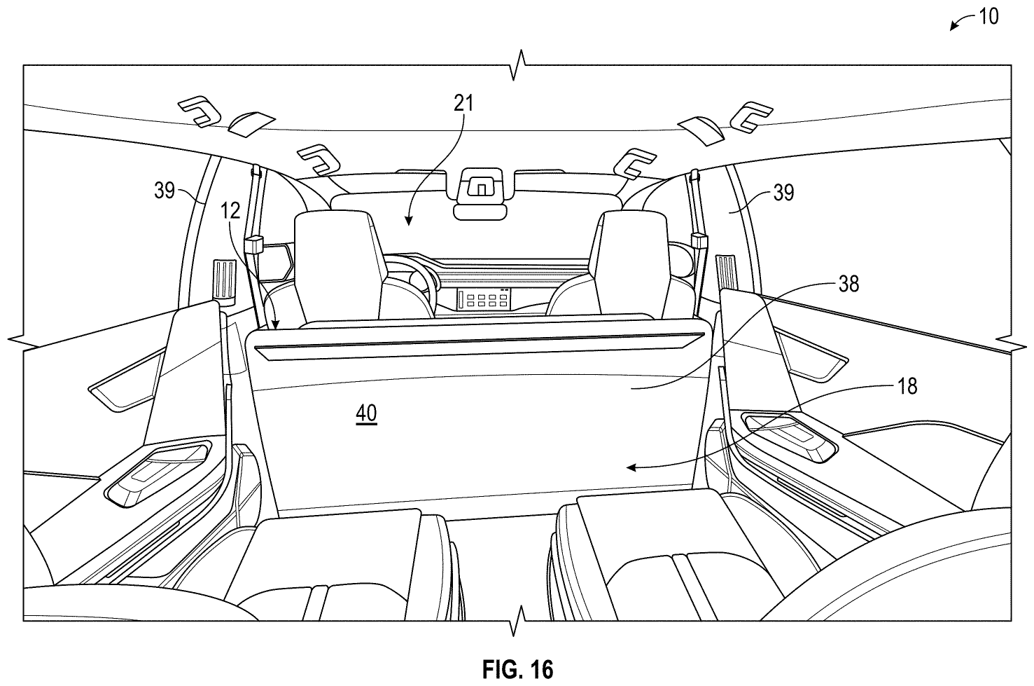

Referring now to FIG. 14, the display screen, monitor or television screen 22 of the privacy window module 12 is in a down position or stowed position and the window or privacy glass 14 is illustrated in the stowed or down position. Thus, an opening 41 is provide in the privacy window module 12.

Referring now to FIG. 15, a regulator 26 for use with the privacy window module 12 of the present disclosure is illustrated. Here the regulator 26 is a dual system regulator wherein a first pair of cursors 42 are slidably received on a pair of guide rails 30 and a second pair of cursors 44 are also slidably received on the pair of guide rails 30. The pair of guide rails 30 are configured so that the first pair of cursors 42 and the second pair of cursors 44 may slide up and down or in opposite directions on the par of guide rails 30 in order to move the display screen, monitor or television screen 22 and the window or privacy glass 14 between the down position or stowed position and the up or deployed position.

The pair of guide rails 30 are configured so that the first pair of cursors 42 and the second pair of cursors 44 may slide up and down or in opposite directions in different paths with respect to each other on the pair of guide rails 30 such that the window or privacy glass 14 and the television screen or display screen 22 may move independently with respect to each other. In this embodiment, the window or privacy glass 14 may be clear or have a PDLC film 20 or tinting secured thereto.

As illustrated, the first pair of cursors 42 are configured to be secured a portion of the window or privacy glass 14. The first pair of cursors 42 are driven up and down the pair of guide rails 30 by a first cable 46 secured to the first pair of cursors 42 at one end and a first cable drum 48 at the other end such that the window or privacy glass 14 may be moved between the stowed or down position and the deployed or up position. The first cable drum 48 being driven by a first motor 50 in order to provide this movement. The second pair of cursors 44 are configured to be secured to a portion of the television screen or display screen 22. The second pair of cursors 44 are driven up and down the pair of guide rails 30 by a second cable 52 secured to the second pair of cursors 44 at one end and a second cable drum 54 at the other end such that the television screen or display screen 22 may be moved between the stowed or down position and the deployed or up position. The second cable drum 54 being driven by a second motor 56 in order to provide this movement.

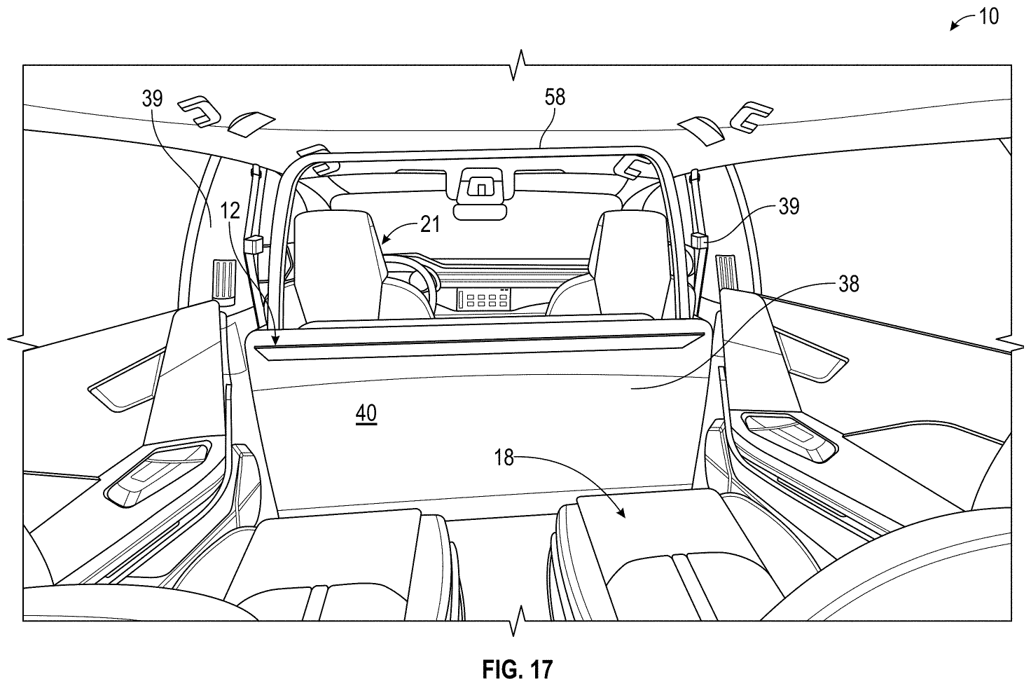

Referring now to FIG. 16, a perspective view of the vehicle interior 10 of a different configuration of the privacy window module 12 of the present disclosure in an open or stowed position. Here the second or passenger interior trim panel 38 has a different configuration. In FIG. 17, the privacy window module 12 of the embodiment of FIG. 16 is in a closed position or deployed position wherein a frame 58 for supporting the window 14 and/or the display screen, monitor or television screen 22 is deployed by a regulator 26.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A privacy window module for use in a vehicle interior, comprising:
a window deployable between a stowed position and a deployed position, the window being movably located between a first panel and a second panel of the privacy window module; and
a screen located on a first surface of the window the screen capable of presenting graphics on its surface.

2. The privacy window module as in claim 1, wherein the window has a polymer dispersed liquid crystal (PDLC) film applied to a second surface of the window, the first surface being opposite to the second surface.

3. The privacy window module as in claim 2, wherein the window transitions from opaque to translucent upon application of a current to the polymer dispersed liquid crystal (PDLC) film.

4. The privacy window module as in claim 2, wherein the first surface is a passenger side surface of the window and the second surface is a driver's side of the window.

5. The privacy window module as in claim 1, wherein the first panel is a driver's side panel and the second panel is a passenger side panel.

6. The privacy window module as in claim 5, wherein the driver's side panel and the passenger side panel are each configured to extend between B-pillars of a vehicle.

7. The privacy window module as in claim 1, wherein the screen is at least one of a video monitor or a television screen.

8. The privacy window module as in claim 1, further comprising a regulator for moving the window between the stowed position and the deployed position, the regulator being secured to either the first panel or the second panel.

9. The privacy window module as in claim 1, wherein an opening is provide in the privacy window module when the window is in the stowed position.

10. A privacy window module for use in a vehicle interior, comprising:
a window deployable between a stowed position and a deployed position, the window being movably located between a first panel and a second panel of the privacy window module; and
a screen deployable between a stowed position and a deployed position, the screen being movably located between the first panel and the second panel of the privacy window module, the screen and the window being capable of independent movement with respect to each other and the screen being capable of presenting graphics on its surface.

11. The privacy window module as in claim 10, wherein the window has a polymer dispersed liquid crystal (PDLC) film applied to a surface of the window.

12. The privacy window module as in claim 11, wherein the window transitions from opaque to translucent upon application of a current to the polymer dispersed liquid crystal (PDLC) film.

13. The privacy window module as in claim 10, wherein when the window is in the deployed position and the screen is in the deployed position, the screen is on a passenger side of the privacy window module and the window is on a driver's side of the privacy window module.

14. The privacy window module as in claim 10, wherein the first panel is a driver's side panel and the second panel is a passenger side panel.

15. The privacy window module as in claim 14, wherein the driver's side panel and the passenger side panel are each configured to extend between B-pillars of a vehicle.

16. The privacy window module as in claim 10, wherein the screen is at least one of a video monitor or a television screen.

17. The privacy window module as in claim 1, further comprising a regulator for moving the window and the screen between the stowed position and the deployable position, the regulator being secured to either the first panel or the second panel.

18. The privacy window module as in claim 17, wherein the regulator is a dual system regulator comprising a first pair of cursors slidably received on a pair of guide rails and a second pair of cursors slidably received on the pair of guide rails, the pair of guide rails being configured so that the first pair of cursors and the second pair of cursors slide in different paths with respect to each other such that the window and the screen move independently with respect to each other, the first pair of cursors being are configured to be secured a portion of the window and the second pair of cursors are configured to be secured to a portion of the screen.

19. The privacy window module as in claim 18, wherein the first pair of cursors are driven up and down the pair of guide rails by a first cable secured to the first pair of cursors at one end and a first cable drum, the first cable drum being driven by a first motor and the second pair of cursors are driven up and down the pair of guide rails by a second cable secured to the second pair of cursors at one end and a second cable drum at the other end, the second cable drum being driven by a second motor.

20. A method of deploying a privacy window module for use in a vehicle interior, comprising:
deploying a window between a stowed position and a deployed position, the window being movably located between a first panel and a second panel of the privacy window module; and
deploying a screen between a stowed position and a deployed position, the screen being movably located between the first panel and the second panel of the privacy window module, the screen and the window being capable of independent movement with respect to each other and the screen being capable of presenting graphics on its surface.
